(19) United States
(12) Patent Application Publication
(10) Pub. No.: US 2008/0128547 A1
(43) Pub. Date: Jun. 5, 2008

(54) Two-stage hypersonic vehicle featuring advanced swirl combustion

(75) Inventors: Robert J. Pederson, Thousand Oaks, CA (US); Stephen N. Schmotolocha, Thousand Oaks, CA (US); William W. Follett, Calabasas, CA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Pratt & Whitney Rocketdyne, Inc., Canoga Park, CA (US)

(21) Appl. No.: 11/633,837

(22) Filed: Dec. 5, 2006

(51) Int. Cl. B64D 27/02; F02K 7/10; B64D 27/16; B64D 27/10; F02K 3/10

(52) U.S. Cl. 244/55; 60/225; 60/768; 60/761

(57) ABSTRACT

The present invention is directed toward a two-stage hypersonic vehicle, comprising a first-stage vehicle and a second stage vehicle. The first-stage vehicle includes a combined-cycle engine and a swirl generator for propelling the first-stage vehicle and the second-stage vehicle to a threshold velocity, which in one embodiment is about Mach 6. In one embodiment, the first-stage combined-cycle engine integrates a swirl generator into a gas turbine engine, providing a highly compact afterburner and a ramjet engine within the gas turbine engine. One benefit of the integrated swirl generator is the ability to significantly reduce overall first-stage gas turbine and afterburner-ramjet size and weight, while retaining high performance. The second-stage vehicle is detachably secured to the first-stage vehicle and includes a hypersonic engine. In various embodiments, the hypersonic engine may comprise one of the following engine configurations: scramjet, rocket, or scramjet/rocket depending on the mission profile and requirements.

### CROSS-REFERENCE TO RELATED APPLICATION(S)

The present application is related to the following copending application filed on the same day as this application: “SINGLE-STAGE HYPERSONIC VEHICLE FEATURING ADVANCED SWIRL COMBUSTION” by inventors, Robert J. Pederson, Stephen N. Schmotolocha and William W. Follett (attorney docket number U73.12-089), which is incorporated herein by this reference.

### BACKGROUND OF THE INVENTION

This invention relates generally to two-stage hypersonic vehicles, and more particularly to propulsion systems for first and second-stage vehicles thereof. Hypersonic vehicles are generally characterized as capable of achieving speeds greater than approximately Mach 5, and have typically relied on rocket engines to achieve such speeds.

Rocket-based launch vehicles or boosters are primarily used to deliver satellites to orbit or weapons, such as intercontinental ballistic missiles (ICBMs), over large distances. However, most existing rocket designs are expendable, making them costly for most missions and less competitive in the world launch market. Additionally, rocket engines require large amounts of fuel and oxidizer to produce thrust, which represents most of the rocket takeoff weight. For example, the Saturn V prior to lift-off for the moon, weighed over 6 million lbs, of which over 4 million lbs was liquid oxygen and only 250,000 lbs was payload. A similar situation is encountered with Space Shuttle. Currently, Shuttle launch costs are approximately $10,000/lb of payload, and expendable rocket vehicles such as Atlas or Delta costs are about $3,000/lb of payload. To achieve a significant reduction in operational costs, advanced aerospace vehicle systems require reusability (eliminating expensive expendable hardware), autonomy (reducing the “standing army” of launch/flight support personnel as on Shuttle) and reducing and simplifying mission propellant needs, such as the need for carrying oxidizer.

A transatmospheric vehicle (TAV) or reusable launch vehicle (RLV) would be capable of returning to earth to be reused after minimal refurbishment and refueling. TAVs most likely would have aerodynamic and operability characteristics similar to conventional aircraft, but have capability of delivering payloads to low earth orbit (LEO). The promise of TAVs is that their reusability would potentially allow them to launch payloads into orbit at much lower cost than current expendable rockets.

Viable alternatives to all-rocket propulsion systems, such as could be used for RLVs, would be a combination of current technologies including gas turbine jet engines, ramjets, scramjets and rockets that can be integrated into a combined-cycle airbreathing propulsion system. Advanced turbojet engines, such as found in fighter aircraft, rely on compressing the air, injecting the fuel into it, burning the mixture, and expanding the combustion products through the nozzle to provide thrust at much higher specific impulses (Isp) than rocket engines. Turbojets can be used to provide horizontal takeoff-like conventional airplanes—and are materials-limited to about Mach 2-3, so as to prevent overheating and cause damage to the turbine blades. In order to go beyond the current Mach 2-3 limitation, up to about Mach 3-4, expensive development of high-temperature gas turbine blade materials technology would be necessary.

In lieu of undertaking this expensive high-temperature materials development, a second propulsion engine, typically a ramjet, can be used to take over thrust production in the Mach 2-3 range. The turbojet by itself would operate from take-off until ramjet takeover. From this threshold point, the vehicle speed powered by ramjet engines can be increased to an upper limit of well beyond the Mach 2-3 limitation of the gas turbine engine. The ramjet engine operates by using a specially designed inlet to scoop up the atmospheric air which is rammed into the engine to be used as an oxidizer. The air comes for free and does not have to be carried onboard the vehicle, as opposed to other oxidizers, like liquid oxygen that constitutes about 66% of vehicle space at launch. The ram air is slowed down and then compressed while the vehicle is flying through the atmosphere. Fuel is injected into the air, mixed with it, combusted and then expanded through the nozzle to provide thrust in a similar fashion to the turbojet. The ramjet would then power the vehicle to its velocity limit of about Mach 6. Above this limit the combustion chamber temperature becomes very high, causing the combustion products to dissociate, which in turn reduces vehicle thrust. Ramjets have previously been successfully integrated into combined-cycle turbojet engines, but resulted in heavy, cumbersome systems that limit overall vehicle performance. For example, the increased weight of previous gas turbine/ramjet designs results in lower achievable speeds for takeover of the second-stage vehicle. Additionally, since ramjet engines operate most efficiently at vehicle speeds beyond about Mach 2-3, this requires higher speeds from the gas turbine engine. Thus, previous attempts at RLVs are limited by the upper speed limits of conventional gas turbine technology, and the size and weight limits of the speed threshold takeover of conventional combined-cycle engines.

To operate at still higher vehicle speeds beyond about Mach 6, supersonic combustion ramjets, or scramjets as they are called, would be employed. Again, fuel is injected, mixed and combusted with the air, but at supersonic speeds, thus necessitating a different fuel injection scheme than that used by the ramjet. As the vehicle continues to accelerate into the upper atmosphere, rocket engines may be required to supplement the scramjet engine(s) for Mach numbers above about 10-12. Certainly, rocket engines would be required if orbit insertion and maneuvering in space (above about Mach 18) were required.

Hypersonic airbreathing TAVs open the possibilities of very attractive, low-operating costs for future vehicles by reducing launch costs from the approximately $10,000/lb payload currently required for Shuttle vehicles to a goal of nearly as little as $100/lb in 2006 dollars. Airbreathing propulsion engines have several advantages over expendable rockets, namely, they do not require stored liquid oxygen, which results in smaller and less costly launch vehicles. In addition, airbreathing engines don't have to rely strictly on engine thrust, but can utilize available aerodynamic forces, thus resulting in a smaller propulsion system as well as far greater vehicle maneuverability. This can also manifest itself in greater vehicle safety since missions can be aborted much easier.

There are two major hypersonic combined-cycle vehicle design approaches for access to space, one featuring a two-stage vehicle and the other a single-stage vehicle. The latter design can also be implemented to achieve fast response global reach and reconnaissance. Typically, two-stage hypersonic vehicles are comprised of a first-stage vehicle responsible for providing thrust from takeoff through subsonic and low supersonic speeds, and up to the ramjet takeover operation. The second-stage vehicle typically operates as a ramjet, followed by the scramjet/rocket mode of operation.

Both two-stage-to-orbit and single-stage-to-orbit RLVs using hypersonic technology have been studied by NASA and others, while single-stage hypersonic vehicles are under consideration by DoD for global strike missions and high altitude reconnaissance. If single-stage and two-stage TAVs could be operated more like an aircraft and less like an expendable rocket, then they would offer the promise of carrying out space operations with greater flexibility and responsiveness than is currently possible with expendable boosters; and would be smaller and extremely cost effective. Both two-stage and single-stage hypersonic TAV designs could be employed to deliver small to medium payloads to LEO, while single-stage hypersonic vehicles offer the promise of launch vehicle responsiveness, flexibility and cost effectiveness for military global strike missions and reconnaissance.

In spite of their attractiveness, such two-stage hypersonic vehicles still have some disadvantages when based on current technologies. For example, a conventional two-stage vehicle would rely on gas turbine technology for first-stage propulsion, and then ramjet/scramjet for second-stage propulsion. Overall vehicle weight of both the first-stage and second-stage vehicles is sensitive to the weight of the propulsion systems. For example, the first-stage vehicle would typically rely on conventional gas turbine technology to achieve speed of about Mach 2-3 before the second-stage propulsion system could begin ramjet operation. In order to operate beyond Mach 3 to speeds on the order of Mach 3-4, a substantial investment in gas turbine technology is required. This technology would typically result in a larger overall vehicle that adversely impacts the performance and the cost of the two-stage hypersonic vehicle. Having to push the current aircraft turbojet engine technology to very high flight speeds on the order of Mach 3-4, so as to prevent turbine blade damage, will require millions to billions of dollars of cost investment by government and industry to develop new high-temperature material technologies. Additionally, second-stage vehicles based on conventional technology would need to include a complex combined-cycle engine that includes a ramjet and a scramjet, and possibly even a rocket operation, thereby increasing size and weight of the second-stage vehicle. Therefore, there is a need for an improved two-stage vehicle having an improved propulsion system that would, among other things, provide the ability to deliver payloads to LEO and reduce substantially the payload delivery cost.

### BRIEF SUMMARY OF THE INVENTION

The present invention is directed toward a two-stage hypersonic vehicle, comprising a first-stage vehicle and a second stage vehicle. The first-stage vehicle includes a combined-cycle engine and a swirl generator for propelling the first-stage vehicle and the second-stage vehicle to a threshold velocity, which in one embodiment is about Mach 6. In one embodiment, the first-stage combined-cycle engine integrates a swirl generator into a gas turbine engine, providing a highly compact afterburner and ramjet engine within the gas turbine engine. One benefit of the integrated swirl generator is the ability to significantly reduce overall first-stage gas turbine and afterburner-ramjet size and weight, while retaining high performance. The second-stage vehicle is detachably secured to the first-stage vehicle and includes a hypersonic engine. In various embodiments, the hypersonic engine may comprise one of the following engine configurations: scramjet, scramjet/rocket, or rocket alone, depending on the mission profile and requirements.

### BRIEF DESCRIPTION OF THE DRAWINGS

FIG. 1 shows a two-stage vehicle in which the propulsion system of the present invention is used.

FIG. 2 shows a first-stage propulsion system with a combined-flow configuration for use in the first-stage vehicle of FIG. 1.

FIG. 3 shows a combined-cycle gas turbine engine having a swirl generator for use in the first-stage vehicle of FIG. 2.

FIG. 4 shows a first-stage propulsion system with a split-flow configuration for use in the first-stage vehicle of FIG. 1.

FIG. 5 shows a swirl generator for use in propulsion systems of the two-stage vehicle of FIG. 1.

FIG. 6 shows a first embodiment of a second-stage propulsion system for use in the second-stage vehicle of FIG. 1.

FIG. 7 shows a second embodiment of a second-stage propulsion system for use in the second-stage vehicle of FIG. 1.

### DETAILED DESCRIPTION

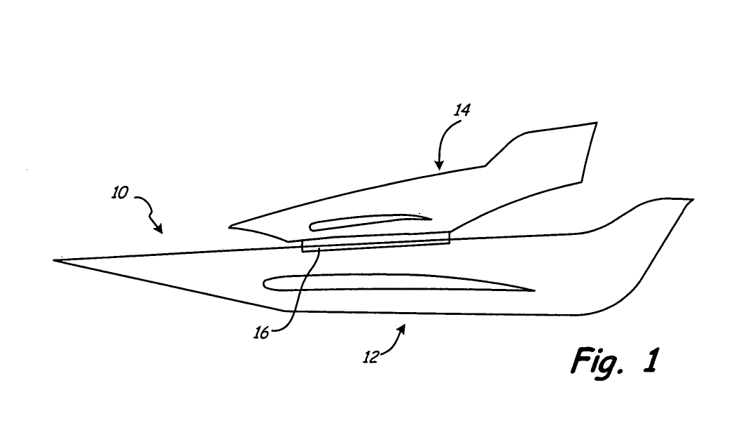

FIG. 1 shows two-stage vehicle 10 of the present invention, comprising first-stage vehicle 12 and second-stage vehicle 14. First-stage vehicle 12 is releasably linked with second-stage vehicle 14 through coupling system 16. Together, first-stage vehicle 12 and second-stage vehicle 14 operate to bring second-stage vehicle 14 to hypersonic speeds of about Mach 5 to about Mach 6. First-stage vehicle 12 includes a combined-cycle, turbo-ramjet engine, including an integrated swirl generator, such that the first-stage vehicle 12 can be brought to ramjet takeover speeds, and then second-stage vehicle 14 can be brought to a scramjet takeover speed. The scramjet takeover speed is typically a speed at which hypersonic propulsion becomes viable and is also known as a hypersonic threshold speed. Such a combined-cycle engine has a great benefit for the two-stage hypersonic vehicle, since the integrated swirl generator can serve as an afterburner and then as a ramjet to allow for a significant reduction in the overall length, weight, cooling requirements, and complexity of the combined-cycle engine, yet retaining high propulsion performance. The combined-cycle, swirl-enhanced engine reduces the requirement for the gas turbine engine to operate all the way up to about Mach 3-4 by lowering the ramjet takeover speed to about Mach 2-3. This simplification can provide a significant investment cost savings in turbojet engine development, since protecting the turbine blades at high velocities and associated high temperatures is extremely difficult. The integrated gas-turbine engine with swirl-afterburner powers the hypersonic vehicle from take-off to a ramjet takeover speed of about Mach 2-3. Using the same swirl generator, the swirl ramjet propulsion system then operates from ramjet takeover speed to a scramjet takeover speed of about Mach 5 to 6, or another hypersonic threshold speed.

Once a threshold speed is obtained, second-stage vehicle 14 separates from first-stage vehicle 12 at coupling system 16. First-stage vehicle 12 is thereafter able to safely return to ground and be reused again. Second-stage vehicle 14 is thereafter operable at hypersonic speeds (from about Mach 5 up to about Mach 18), unencumbered by the additional weight and size of larger first-stage vehicle 12. In one embodiment, second-stage vehicle 14 operates as a pure scramjet. In other embodiments the propulsion system of second stage vehicle 14 could be a rocket, scramjet or a scramjet/rocket.

Scramjet operation requires a continuous supersonic isolator airflow to sustain combustion necessary for propulsion. Thus, in order for second-stage vehicle 14 to operate properly as a scramjet, it must be brought up by another source to a particular threshold speed sufficient to achieve supersonic or hypersonic combustion (typically defined as M>5) operation. In the present invention, a two-stage vehicle design is used such that first-stage vehicle 12 is used to initially propel second-stage vehicle 14 to a hypersonic threshold speed of about Mach 5 to about Mach 6. As indicated above, current technology is limited in the ways in which the propulsion systems can be split between the first and second-stage vehicles. For example, a first stage vehicle could use turbojet engines to accelerate both vehicles to about Mach 3-4, whereby a ramjet/scramjet/rocket second-stage vehicle would deliver the second-stage vehicle to space or provide a sub-orbital fast response global reach. However, this combined-cycle propulsion approach for the first-stage vehicle places a great technical and financial burden in achieving breakthroughs in turbine blade materials technology to enable operating at sustained high temperatures at Mach 3-4 speeds. In the present invention, first-stage vehicle 12 includes advantages such as integrating advanced swirl technology into a compact turbojet engine afterburner/ramburner, and thus the second-stage vehicle 14 could operate strictly as a scramjet, or a scramjet/rocket if space access or fast response global reach is required. Using advanced swirl combustion, the present invention achieves advantages over previous first-stage combined-cycle propulsion approaches, including reducing complexity and cost of developing the turbojet engine since its required maximum speed is reduced to about Mach 2 to about Mach 3. Also, the second-stage vehicle complexity and weight is reduced because a ramjet engine would not be required.

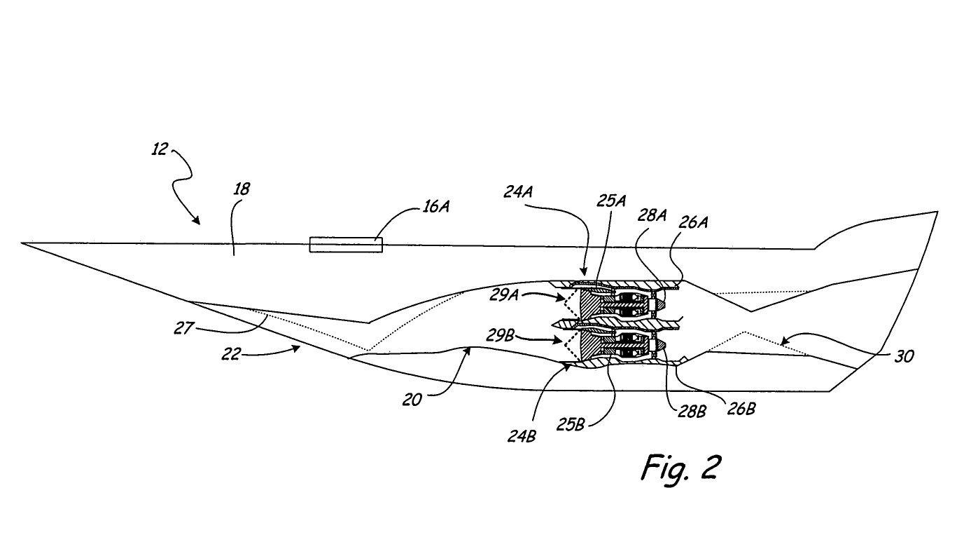

FIG. 2 shows first-stage vehicle 12, including fuselage 18 and first-stage propulsion system 20 having a combined-flow, combined-cycle configuration. Propulsion system 20 includes air flowpath 22, gas turbine turbojet engines 24A and 24B, including ramjets 25A and 25B, swirl-afterburners 26A and 26B and swirl generators 28A and 28B. Vehicle 12 also includes other components required for controlling and propelling vehicle 12, such as flight control systems and fuel systems, which are not shown for clarity, but are well known in the aerospace industry. Fuselage 18 also includes first-stage coupling unit 16A used to link first-stage vehicle 12 with second-stage vehicle 14. Fuselage 18 is configured for achieving flight when propelled at sufficient speeds by first-stage propulsion system 20.

Propulsion system 20 is a combined-cycle engine operable as a gas turbine/afterburner/ramjet using advanced swirl combustion. Gas-turbine engines 24A and 24B with swirl afterburners 26A and 26B operate to initially accelerate first-stage vehicle 12 from standstill to a speed suitable for ramjet combustion and takeover, which occurs at approximately Mach 2 to approximately Mach 3. At a ramjet takeover speed, gas-turbine engines 24A and 24B shutdown, and ramjets 25A and 25B are able to assume control of thrust production. Gas-turbine engines 24A and 24B include variable ducting such that they can shift between gas turbine operation and ramjet operation. Together, variable area inlet 27, variable ducts 29A and 29B of gas turbine engines 24A and 24B, ramjets 25A and 25B and variable area nozzle 30 function as a converging/diverging nozzle for ramjet flowpath operation. Swirl generators 28A and 28B are positioned in air flowpath 22 between inlet 27 and nozzle 30, and are functional as ramjets, as well as afterburners for the gas turbine engine. Thus, as will be further elaborated below, first-stage propulsion system 20 reduces size and weight by using advanced swirl combustion to reduce afterburner and ramjet combustor length when integrated into each gas turbine and combined-cycle propulsion system.

With size and weight saving advantages of combined-cycle, propulsion system 20, the design and performance flexibility of first-stage vehicle 12 also increases. For example, first-stage vehicle 12 is able to package gas turbine, afterburner and ramjet propulsion systems into a single compact combined-cycle propulsion engine, thus achieving higher threshold speeds, of about Mach 5 to about Mach 6 in a smaller vehicle size. This can ultimately increase payload capabilities, thereby reducing the cost per pound of useable payload.

Swirl generators 28A and 28B used in first-stage vehicle 12, as will be discussed below, also simplify the propulsion system of second-stage vehicle 14 due to the possibility of eliminating the need for a ramjet engine, leaving only a scramjet/rocket, which reduces overall first and second stage vehicle weight, permitting a larger payload.

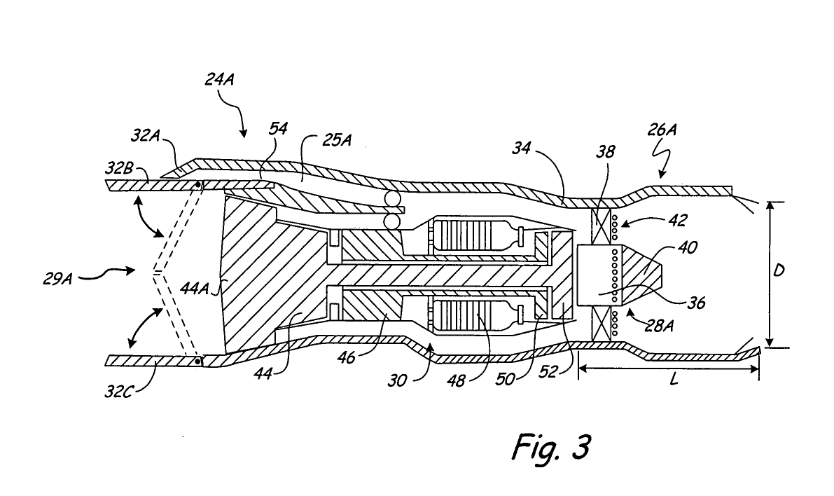

FIG. 3 shows one embodiment of gas-turbine engine 24A having swirl generator 28A for use in first-stage vehicle 12 of FIG. 2. Gas-turbine engine 24A is shown as a combined-cycle turbo-ramjet engine into which an afterburner/ramjet propulsion system is integrated. An in-depth description of swirl generators and augmentation used in the present invention is found in “COMBINED CYCLE ENGINES INCORPORATING SWIRL AUGMENTED COMBUSTION FOR REDUCED VOLUME AND WEIGHT AND IMPROVED PERFORMANCE,” U.S. Pat. No. 6,907,724 by Edelman et al., which is incorporated by this reference. Here, a brief overview of gas turbine engine 24A is provided so that the advantages of the present invention are more readily understood.

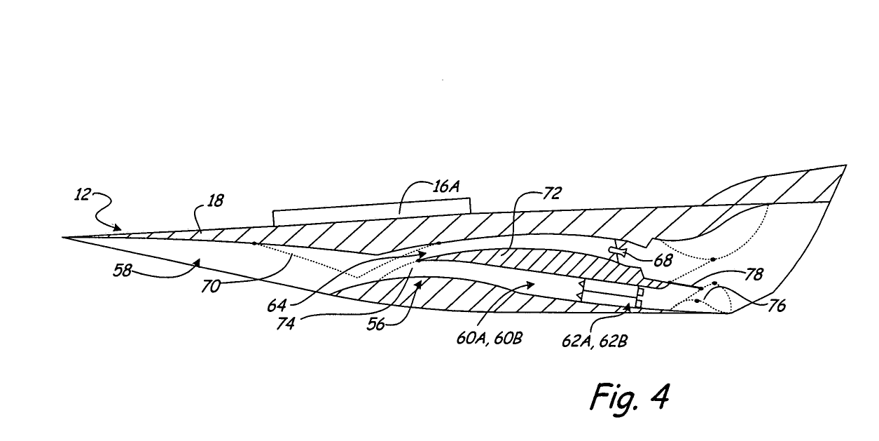

Gas-turbine engine 24A includes swirl generator 28A, ramjet 25A, swirl-afterburner 26A, core engine 30, ramjet cowl 32A, first turbine cowl 32B, second turbine cowl 32C and exhaust duct 34. Swirl generator 28A, the details of which are disclosed in “COMPACT, LIGHTWEIGHT HIGH-PERFORMANCE LIFT THRUSTER INCORPORATING SWIRL-AUGMENTED OXIDIZER/FUEL INJECTION, MIXING AND COMBUSTION,” U.S. Pat. No. 6,820,411 by Pederson et al., which is incorporated by this reference, includes centerbody 36, variable swirl vanes 38, centerbody cone 40 and a plurality of fuel injectors 42. Core engine 30 comprises typical gas turbine technology such as low pressure compressor 44 (including bypass fan portion 44A), high pressure compressor 46, main combustion chamber 48, high pressure turbine 50 and low pressure turbine 52. Ramjet 25A includes duct or isolator 54. As mentioned earlier, combined-cycle gas-turbine engine 24A includes variable duct 29A such that it can translate between operating as gas turbine and a ramjet. In the embodiment shown, variable duct 29A comprises ramjet cowl 32A, first turbine cowl 32B and second turbine cowl 32C such that they act together to control airflow between core engine 30 and ramjet 25A. FIG. 4 shows one embodiment of the variable ducting for gas-turbine engine 24A, although the ducting can be modified or adjusted as is known in the art for different designs. For example, the variable ducting may be optimized for aerodynamic flow within the specific ducting of each propulsion system or vehicle.

As shown in FIG. 3, inlet air enters low pressure compressor 44 when first turbine cowl 32B is in a horizontal position (as shown in solid lines) and second turbine cowl 32C is in a horizontal position (as shown in solid lines). As such, core engine 30 is functional as a typical gas-turbine engine. In this configuration, first turbine cowl 32B contacts ramjet cowl 32A such that air is prevented from entering isolator 54. Additionally, in this mode, swirl vanes 38 of swirl generator 26A would be aligned with the airflow to permit unobstructed flow during normal gas turbine operation. For example swirl vanes 38 could be aligned parallel to the direction of flow to cancel swirl and prevent undue pressure loss in the airflow for ramjet operation. During afterburner mode, however, swirl vanes 38 are rotated about their vertical axis or otherwise skewed to the direction of flow to produce swirl to the gas turbine combustion constituents to shorten the afterburning mixing-combustion processes. For example, a controller can be used to automatically set the angle of swirl vanes 38 to a predetermined design value so as to generate the requisite swirling flowfield for afterburning operation. Thus, first-stage vehicle 12 can be brought from a zero velocity up to a velocity suitable for take-off and flight by core engine 50. Subsequently, ramjet 25A can be used to propel first-stage vehicle 12 up to a hypersonic (scramjet) threshold takeover velocity.

For ramjet operation, inlet air enters isolator 54 between ramjet cowl 32A and first turbine cowl 32B when first turbine cowl 32B is in a retracted position (as shown by dashed lines) and second turbine cowl 32C is in a retracted position (as shown by dashed lines). In this configuration, first turbine cowl 32B contacts second turbine cowl 32C such that air is prevented from entering core engine 30. As such, inlet air can flow around core engine 30, unobstructed to swirl generator 28A for ramjet combustion. Additionally, in this mode, swirl vanes 38 of swirl generator 26A would be rotated skewed to the direction of flow to produce swirl in the airflow and to shorten the mixing-combustion processes. For example, an engine controller could set the rotation of swirl vanes 38 to a predetermined design angle to produce the required amount of swirl for ramjet operation. Core engine 30 is also insulated such that it is able to withstand elevated temperatures reached during ramjet operation. Thus, in both operational modes, core engine 30 and ramjet 25A are able to utilize the same swirl generator 28A.

Swirl generator 28A includes two purposes, first to act as a gas turbine afterburner 26A, if required, or when inlet air bypasses gas turbine engine 30 through isolator 54, it functions as a ramjet with ramjet engine 25A. Swirl generator 28A enhances the performance of swirl-afterburner 26A such that the length and weight of swirl-afterburner 26A is considerably reduced as compared to conventional afterburners. An in-depth description of swirl-enhanced mixing-combustion to improve performance of gas turbine afterburner 26A used in the present invention is found in “COMPACT SWIRL AUGMENTED AFTERBURNERS FOR GAS TURBINE ENGINES,” U.S. Pat. No. 6,895,756 by Schmotolocha et al., which is incorporated by this reference. Here, a brief overview of swirl-afterburner 26A is provided so that the advantages of the present invention are more readily understood.

For conventional afterburner operation, it would typically be necessary to position a series of fuel spray bars just downstream of the exhaust duct 34 in order to provide fuel for combusting in the afterburner. Typically, five to seven injector segments are necessary. Additionally, a plurality of flameholders are required downstream of the spray bars to anchor the flame and ensure stable, self-sustained combustion. Thus, in order to achieve thrust augmentation with a conventional afterburner, the exhaust duct must be lengthened to include spray bars and flameholders as well as provide sufficient residence time for afterburning the fuel. This adds considerable length and weight to the engine. Conventional afterburners may additionally include a diffuser cone to reduce pressure losses, and is positioned downstream of the low-pressure turbine 52. Typically, conventional afterburner systems require a combustion chamber (called afterburner) having a length-to-diameter ratio (L/D) of about 4.

Utilizing swirl generator 28A, the present invention is able to achieve an afterburner L/D of 1.6 or less, resulting in about a 60% reduction in afterburner length and thus also reduced weight. During operation of core engine 30, swirl generator 28A swirls and mixes air-rich hot gases exiting combustor 48 after they pass through high pressure turbine 50 and low pressure turbine 52, and compressed bypass air that exits bypass fan 44A. Swirl generator 28A also swirls and mixes bypass air that is compressed as it exits bypass fan portion 44A of low pressure compressor 44. During operation of ramjet 25A, swirl generator 28A swirls the compressed air exiting ramjet inlet isolator 54. Swirl generator 28A imparts a swirling three-dimensional flowfield aerodynamics on the combined hot-gas and cold-air streams providing rapid intermixing of the two streams, followed by just as rapid mixing of both oxygen-rich streams with the injected afterburner fuel, and then effectuates rapid and efficient afterburning.

Swirl generator 28A includes a swirl generator that, as described above, improves mixing of the combustible constituents and flame propagation and spreading such that combustion processes are accelerated during both gas-turbine and ramjet operation. Particularly, combustion is completed more quickly and completely than compared to a conventional ramjet combustor. In the latter case, the fuel is injected into the high-velocity airstream, and the mixture is typically expanded into sudden dump combustor where combustion takes time (and length) to complete. However, in case of the present invention, since combustion occurs more rapidly, a shorter combustor can be used, thereby reducing the length of swirl-afterburner 26A. Additionally, fewer components are necessary, reducing the weight of afterburner 26A. As a result of the decreased size of afterburner 26A, cooling requirements for gas-turbine engine 24A are also reduced, which further increases the weight-saving advantages of afterburner 26A.

Therefore, gas turbine engine 30, when combined with swirl-afterburner 26A, is able to reach peak flight speeds with a lighter engine. In one embodiment, combined-cycle engine 24A propels two-stage hypersonic vehicle 10 to about a Mach 2.5-3.0 flight speed regime, and the swirl-enhanced ramjet then accelerates to the Mach 6 range. With a lighter combined-cycle turbojet/ramjet engine, two-stage vehicle 10 is more readily able to reach higher velocities. Particularly, combined-cycle engine 24A is able to reach speeds suitable for sustaining scramjet operation such that scramjet propulsion can be uncoupled from first-stage propulsion system 20.

Since the unique combination of a swirl afterburner/ramjet design can play a double role (either as a gas turbine afterburner or a ramjet by using bypass doors to route the air around the outside of the gas turbine engine core to the swirl combustor as in FIG. 3), then the standard gas turbine afterburner length can be dramatically reduced. The benefits to be gained amount to an estimated 60% reduction in traditional gas turbine afterburner length, reduced weight and heat load due to a shorter afterburner length (as described above) and higher thrust-to-weight ratio. A split flowpath for gas turbine engine 24A and ramjet 25A, as described in greater detail below with respect to FIG. 4, is also an option for first-stage vehicle 12. Therefore, powered by afterburning gas turbine engine 24A, first-stage vehicle 12 is able to reach peak speeds with a lighter engine. In one embodiment, typical core engine 30 can achieve speeds in approximately the Mach 2-3 range. However, with a lighter combined core/ramjet engine, such as engine 24A, first-stage vehicle 12 is more readily able to reach higher velocities on the order of Mach 6, velocities viable for scramjet, scramjet/rocket, or rocket operation.

Returning to FIG. 2, first-stage vehicle 12 combines combustor length, weight and size saving advantages such that first-stage propulsion system 20 is expected to be able to achieve threshold velocities of up to about Mach 6. Particularly, gas turbine engines 24A and 24B are combined into flowpath 22 with swirl afterburners/ramjets 28A and 28B using variable ducting in a configuration such that size and weight of first-stage propulsion system 20 is reduced. Furthermore, gas turbine engines 24A and 24B include swirl generators 28A and 28B that reduce length and weight of gas turbine engines 24A and 24B. For example, swirl generators 28A and 28B function with both gas-turbine engines 24A and 24B as afterburners, or as ramjets in conjunction with ramjets 25A and 25B, as shown in the combined-flow configuration of FIG. 2. These volumetric and weight saving features result in significant enhancement in the design and performance of first-stage vehicle 12. For example, first-stage vehicle 12 benefits from increased range due to weight savings. Additionally, due to weight reduction without a sacrifice in thrust production, first-stage vehicle 12 achieves increased thrust-to-weight ratio. This then affords to carry substantially more payload, thereby reducing the hypersonic vehicle's operational costs from the current $10,000/lb payload down to a much more attractive $100/lb payload; i.e., two orders of magnitude (100 times) cost savings. In the embodiment of FIG. 2, two gas turbine engines are shown, but only for illustration purposes. For those skilled in the art, it is recognized that additional engines may be required, depending on mission requirements. In other embodiments, first-stage vehicle 12 and propulsion system 20 can be arranged in other configurations.

FIG. 4 shows a second embodiment of first-stage propulsion system. First-stage propulsion system 56 features integrated gas turbine and ramjet engines with a split-flowpath over/under design for use in first-stage vehicle 12 of FIG. 1. First-stage vehicle 12 includes fuselage 18, in which is positioned first-stage propulsion system 56. Propulsion system 56 includes flowpath 58, gas turbine engines 60A and 60B, and swirl afterburners 62A and 62B, (similar to that of afterburner 26A of FIG. 3), ramjet engine 64 and swirl generator 68 (similar to that of swirl generator 28A of FIG. 3). Propulsion system 56 operates analogously to propulsion system 20 of FIG. 2, however ramjet 64 is split apart from gas turbine engines 60A and 60B and placed into its own portion of air flowpath 58. Vehicle 12 also includes flow control components such as variable inlet duct 70, barrier 72, entrance gate 74, variable nozzle 76 and exit gate 78. Additionally, vehicle 12 includes other components required for controlling and propelling it, such as flight control systems and fuel systems, which are not shown for clarity, but are well known in the aerospace industry. Fuselage 18 also includes first-stage coupling unit 16A which is used to link first-stage vehicle 12 with second-stage vehicle 14. Fuselage 18 is configured for achieving flight when propelled at sufficient speeds by first-stage propulsion system 56.

Propulsion system 56 is a combined-cycle engine operable as a gas turbine with swirl afterburner and a ramjet. Gas turbine engines 60A and 60B with swirl afterburners 62A and 62B and ramjet 64 are integrated into fuselage 18 in a split-flowpath configuration such that they each occupy a separate portion of flowpath 58. The flowpath of gas turbine engines 60A and 60B with swirl afterburners is separated from the flowpath of the ramjet 64 and swirl generator 68 by barrier 72. During operation of gas-turbine engines 64A and 64B, variable inlet duct 70, gate 74 and gate 78 close off the airflow to ramjet 64. Gas turbine engines 60A and 60B with swirl afterburners 62A and 62B operate to initially accelerate first-stage vehicle 12 from standstill until its flight is attained. Gas turbine engines 60A and 60B with swirl afterburners 62A and 62B are further able to accelerate first-stage vehicle 12 to a speed suitable for a ramjet takeover operation, which is in about the Mach 2-3 range.

At a ramjet takeover speed, gas-turbine engines 60A and 60B shut down, and ramjet 64 takes over thrust production. First, however, variable inlet duct 70 and gate 74 operate to close off airflow to gas turbines 60A and 60B and direct air to ramjet 64. Thus, air flowpath 58, in conjunction with variable inlet duct 70, gate 74, variable area nozzle 76 and gate 78, are then operable as a ramjet. Entrance gate 74 and exit gate 78 close off the flowpath of gas turbines 60A and 60B such that a continuous flow is maintained through ramjet 64. Variable area nozzle 76 functions as a converging/diverging nozzle for ramjet operation. Swirl generator 68 is positioned in air flowpath between inlet duct 70 and nozzle 76, for ramjet operation. Due to the ability of swirl generator 68 to produce very high turbulence intensities and early merging of shear layers; fuel atomization, vaporization, mixing, and flame spreading/propagation are increased many fold, resulting in more efficient combustion in a shorter combustor length. Air flowpath 58 can then be significantly reduced, thus increasing the ability and efficiency of first-stage vehicle 12 to achieve higher scramjet takeover speeds to the scramjet powered second-stage vehicle 14. In a split-flow configuration, swirl generator 68 operates as an independent ramjet engine, however, gas turbine engines 60A and 60B incorporate high performing swirl-afterburners 62A and 62B that are much shorter than traditional designs due to use of advanced swirl combustion described herein.

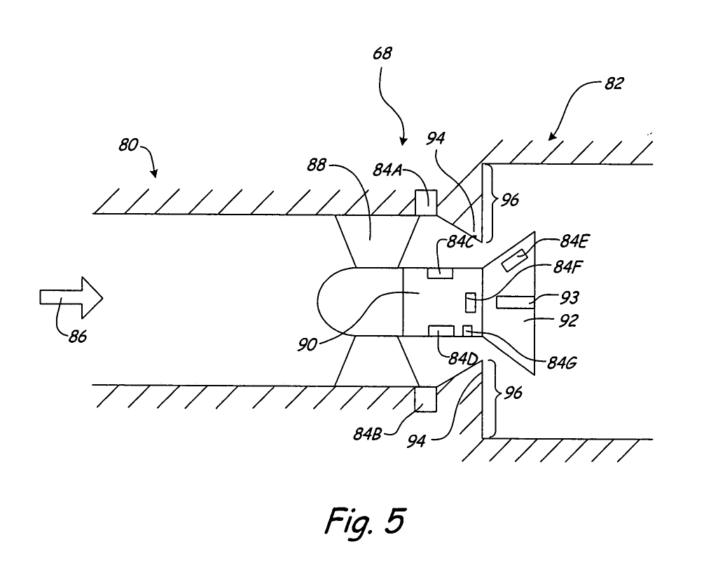

FIG. 5 shows swirl generator 68, which embodies advanced swirl combustion technology, for use in the propulsion systems of two-stage vehicle 10 of FIG. 1. This technology is integrated into a cohesive turbojet, afterburner and ramjet combined-cycle propulsion system 56 shown in FIG. 4. Swirl generator 68 operates in a similar fashion to that of swirl generator 28A of FIG. 3. Swirl generator 68 improves mixing between two combustion constituents, e.g. a fuel and an air oxidizer, which are integrated into a gas turbine and ramjet propulsion engine. Swirl generator 68 enhances mixing such that combustion can be more completely and rapidly carried out, enabling shorter and lighter components such as combustors. Thus, two-stage vehicle 10, by incorporation of swirl combustion technology, is able to improve performance parameters such as increased thrust-to-weight ratios due to a reduction in afterburner-ramjet combustor length and reduced weight. An in-depth description of swirl combustion used in the present invention is found in “COMPACT, LIGHTWEIGHT HIGH-PERFORMANCE LIFT THRUSTER INCORPORATING SWIRL-AUGMENTED OXIDIZER/FUEL INJECTION, MIXING AND COMBUSTION,” U.S. Pat. No. 6,820,411 by Pederson et al., which is incorporated by this reference. Here, a brief overview is provided so that the advantages of the present invention are more readily understood.

Swirl generator 68 includes air delivery duct 80, combustion chamber or combustor 82 and a set of fuel injectors 84A-84G. Delivery duct 80 directs a first combustion constituent, typically air oxidizer 86, toward combustion chamber 82. Swirl generator 68 includes swirl vanes 88, centerbody 90, bluffbody 92, igniter 93, ramp 94 and sudden dump step 96. Swirl generator 68 imposes a swirling flow upon the air oxidizer 86, which, upon mixing with a second combustion constituent,—typically injected fuel—are burned to produce thrust, thereby producing a more efficient, shorter combustion process.

Air oxidizer 86 enters delivery duct 80 in a generally axial direction. Swirl vanes 88 impart tangential and radial velocities into combustion constituent 86 and the injected fuel, thereby producing a highly turbulent, three-dimensional flowfield having a large central recirculation zone (CRZ) downstream of the bluffbody 92. Swirl vanes 88 are variable such that, depending on the operational mode of propulsion system 56 they can be aligned with the airflow to not produce swirl, or aligned skewed to the airflow such that they produce swirl. In one embodiment, there are twelve vanes in a vane pack having an approximately flat profile (number of swirl vanes are dependent on the size of the propulsion engine). In propulsion system 56 (FIG. 4), air 86 is delivered directly to the ramjet engine 64. (Similarly, air 86 is passed through gas turbine engines 60A and 60B, mixed with fuel, and combusted as it enters swirl afterburners 62A and 62B (similar to afterburner 26A of FIG. 3) to augment the combustion efflux temperature). As shown in FIG. 5, swirl generator injectors 84A-84G introduce a second combustion constituent, such as an aerospace grade fuel, into the vortex flow of first combustion constituent 86. Due, in part, to the three-dimensional flowfield produced by swirl vanes 88 in the CRZ, highly efficient mixing of air 86 and the second combustion constituent is achieved. Injectors can be positioned in various combinations along the perimeter of the fuel delivery manifolds, namely: in the outer wall of the air delivery duct 80, such as injectors 84A and 84B; in centerbody 90, such as injectors 84C, 84F, 84G and 84D; or in bluffbody 82, such as injector 84E. Injectors 84A-84G may comprise orifice type, simplex, or fan spray atomizer injectors, as well as other injector designs that are known to those who are skilled in the art.

Centerbody 90 links vanes 88 with bluffbody 92 and houses other components such as midstream injectors 84C and 84F, and igniter 93. Bluffbody 92 anchors the CRZ such that combustion is stabilized immediately downstream of swirl generator 68, as it enters combustor 82. As the mixed combustion constituents enter combustor 82, ramp 94 and dump-step 96 separate the outer boundary layer and its flowfield, which produce a toroidal outer recirculation zone (ORZ) in the three-dimensional flowfield. Dump-step 96 can be aerodynamically shaped to produce and stabilize the ORZ, while aerodynamically shaped ramp 94 compresses the combustion constituents, intensifies shear layers of the ORZ and CRZ and increases the amount of mass entrainment into both the ORZ and the CRZ. An optional ignition system can be located in swirl generator 68, such as igniter 93, to initiate a combustion process with the combustion constituents as they enter combustor portion 82. The location of igniter 93 could alternately be utilized as a fuel injection site, if required. Optional igniter(s) may be placed in the dump-step region of the ORZ as may be dictated by design variances in the flowpath of incoming oxidizer 86 and/or geometry of the swirl generator. A dump-step ignition system could be applied to a separate stand-alone ramjet flowpath or as in the case of a combined-cycle gas turbine swirl afterburner/ramjet flowpath, as shown in FIG. 2. Bluffbody 92 comprises a channeled flare at the trailing edge of centerbody 90 that further enhances the mixing of the combustion constituents and pushes the CRZ radially outward as it enters combustor portion 82 so that adjacent shear layers of the CRZ can merge sooner with the ORZ shear layer. Bluffbody 92 also anchors the CRZ and along with the ORZ provides a flame anchor for the robust flame spreading and combustion processes. In various embodiments, bluffbody 92 also contains orifice injectors such as injector 84E. In one embodiment, bluffbody includes about a 25° flare having ten channels, but these parameters can be adjusted to produce the desired amount of turbulence in the flowfield.

Injectors 84A-84G are positioned such that the second combustion constituent (fuel) will be optimally injected into flowfields of combustion constituent 86 in the ORZ and CRZ. The combined highly turbulent swirling flowfield downstream of bluffbody 92, including both shear layers and the ORZ and CRZ, provides more effective mixing of the combustion constituents as they enter combustor portion 82, and considerably accelerates combustion processes used for producing thrust. The combined effects of this flow aerodynamics is much faster mixing, atomization, evaporation and higher chemical-kinetic reaction/combustion rates, which result in much higher combustion efficiency, combustion stability, and wider flammability limits. Since the combustion constituents are better entrained, complete combustion of the constituents can be achieved more rapidly, particularly in the field of interaction between the ORZ and CRZ where shear stresses are high and where the main combustion takes place. Thus, with the accelerated combustion process, shorter combustors can be used in propulsion systems when employing swirl generators such as swirl generator 68. Additionally, the configuration of swirl generator 68 produces a controlled rapid rise of the swirl during fuel injection, followed immediately by a rapid decay of the swirl during the combustion process, thus ensuring about 99% of thrust recovery in a short-length combustor.

For any configuration of first-stage vehicle 12, such as in FIG. 2 or FIG. 4, due in part to the size and weight saving advantages, the first-stage propulsion system is able to accelerate two-stage vehicle 10 up to a threshold speed suitable for initiating hypersonic (approximately Mach 5 to approximately Mach 6) combustion. For example, size and weight reductions are achieved by integrating gas turbine engines 24A and 24B and ramjets 25A and 25B into a combined-flow, combined-cycle propulsion system (FIG. 2). Also, size and weight reductions are achieved by including swirl afterburners 62A and 62B into gas turbine engines 60A and 60B (FIG. 4). Size and weight reductions are achieved by incorporating swirl generators 28A and 28B into gas turbine engines 24A and 24B (FIG. 2). Additionally, swirl generator 68 is incorporated into flowpath 58 to reduce the size and length of ramjet 64 (FIG. 4) When brought up to the threshold speed by first-stage vehicle 12, second-stage vehicle 14 can operate as a pure scramjet, rocket or scramjet/rocket, thus realizing significant cost savings in gas turbine engine development. This is due to the fact that present invention uses an integrated gas turbine/swirl-afterburner/swirl-ramjet combined-cycle engine for the first-stage vehicle that requires the gas turbine to only have to operate up to about Mach 2 to about Mach 3 instead of about Mach 3 to about Mach 4. Also, the second-stage vehicle can then be made significantly shorter, simpler and lighter without the need for the ramjet engine.

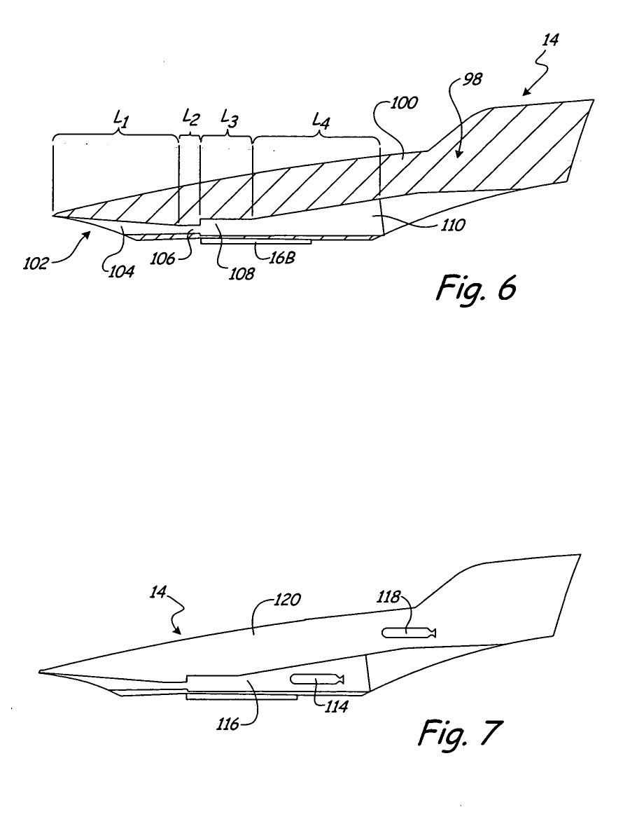

FIG. 6 shows a partial cross section of second-stage vehicle 14 having second-stage propulsion system 98 for use in two-stage vehicle 10 of FIG. 1. Second-stage vehicle 14 comprises fuselage 100, in which is contained second-stage coupler 16B, which links with first-stage coupler 16A of first-stage vehicle 12. Vehicle 14 also includes other components required for controlling and propelling it, such as flight control systems and fuel systems, which are not shown for clarity, but are well known in the aerospace industry. Fuselage 100 also includes second-stage propulsion system 98, which comprises air capture inlet intake 102, inlet duct 104, isolator 106, expanding combustor 108 and variable-geometry divergent exit nozzle 110. Second-stage propulsion system 98 is configured to operate as a scramjet or scramjet/rocket at hypersonic velocities.

Since pure scramjet operation requires a continuous supersonic airflow to maintain combustion, second-stage vehicle 12 relies on first-stage vehicle 14 for attaining flight speeds viable for scramjet operation. At the ramjet-to-scramjet handover speed, air enters intake 102, scramjet fuel is injected into combustor 108 and scramjet propulsion is then initiated. Note that the air enters capture inlet intake 102 at supersonic speeds and is then continuously decelerated along inlet duct 104. Inlet duct 104 has a length L₁, over which its cross-sectional area decreases such that the supersonic inlet airflow is compressed and decelerated prior to entering isolator 106. The supersonic air proceeds into isolator 106, which controls the airflow exiting inlet duct 104. Isolator 106 has length L₂ and acts as a buffer section between inlet duct 104 and supersonic ramjet combustor 108. Length L₂ depends on the flight speed at which the incoming air is captured by inlet intake 102 and passed on through to inlet duct 104 and the speed of air required for sustaining supersonic or hypersonic combustion in second-stage propulsion system 98 (which is typically the hypersonic threshold speed or scramjet takeover speed). Isolator 106 prevents inlet unstart (subsonic flow in the inlet with high drag) and optimizes air speeds for combustion in combustor 108. Supersonic combustor 108 has length L₃ that is optimized for fully burning fuel in the air stream based on the scramjet takeover speed. After passing through combustor 108, the supersonic products of combustion pass through exhaust nozzle 110 as they exit second-stage propulsion system 98. Exhaust nozzle 110 has length L₄, over which its cross-sectional area increases such that the supersonic flow can expand to produce thrust for propelling and maneuvering second-stage vehicle 14.

The overall length of inlet air flowpath, including L₁, L₂, L₃ and L₄, is determined by the staging Mach number. The staging Mach number is the speed at which second-stage vehicle 14 separates from first-stage vehicle 12, and is typically the speed at which ramjet/scramjet operation is viable for the ramjet/scramjet second-stage vehicle, e.g. the supersonic or hypersonic threshold speed. For example, ramjet operation typically requires speeds of about Mach 2 to about Mach 3 to be efficient. However, the lower the staging Mach number is, the longer the resulting inlet flowpath must be. Correspondingly, higher staging Mach numbers allow for shorter, lighter second-stage propulsion systems. With conventional gas turbine and ramjet technology, staging Mach numbers typically reach about Mach 2.5 to about Mach 3. Ramjets require much longer isolators and combustors than scramjets because they require that the speed of the airflow be controlled more carefully. For example, ramjet operation requires that the supersonic freestream Mach number be reduced to a subsonic Mach number within the inlet isolator, which is prior to entering the combustion chamber such that subsonic combustion can take place. A diffuser can be integrated into the isolator length to shock down the supersonic airflow to subsonic speeds. Therefore, ramjet propulsion systems require additional isolator and combustor lengths. Additionally, during ramjet operation, in which the supersonic air is slowed down to subsonic levels, pressure imbalances due to, for example, shock waves may develop in the airflow during operation. The subsonic flows have a tendency to advance forward in the flowpath and slow the flow stream to a point where the ramjet will not function properly. Therefore, an isolator having a sufficient length can be used to prevent shock waves and airflow reversal.

In one embodiment, second-stage propulsion system 98 is configured for pure scramjet operation, resulting in a lighter, more compact second-stage vehicle. Because the staging Mach number for two-stage vehicle 10 is sufficiently high (Mach 5 to 6), components necessary for ramjet operation can be removed in propulsion system 98 such that only scramjet operation occurs. Therefore, the second-stage propulsion system 98 operates as a pure scramjet, i.e. without the assistance of a ramjet, and does not operate at subsonic speeds as is required in a ramjet. Hence, propulsion system 98 does not need additional ramjet isolator length, which could also include a diffuser. Thus, length L₂ of isolator 106 can be shortened. Thus, length L₃ of combustor 108 can be reduced and propulsion system 98 is significantly reduced in size and length as compared to ramjets or combined ramjet/scramjets.

Due to the size and weight saving advantages of first-stage vehicle.12, including benefits derived from swirl generators, the staging Mach number for two-stage vehicle 10 is expected to be pushed to about Mach 5 to about Mach 6. This results in the length of propulsion system 98 being significantly reduced from a two-stage vehicle featuring a combined ramjet/scramjet. Based on various test results, calculations and assumptions, it is expected that isolator 106 can be reduced about 35% to about 65%, and supersonic combustor 108 can be reduced by about 50% or more as compared to a conventional ramjet/scramjet propulsion system. Thus, the overall length of flowpath 102 can be reduced about 13% to about 38%, resulting in a reduction in weight of second-stage vehicle 14, thereby increasing its cost per useable payload ratio. Additionally, since flowpath 102 is significantly reduced in length, the cooling system for vehicle 14 can be correspondingly reduced in capacity, further reducing the weight of vehicle 14. Also, since subsonic flows are eliminated, the required range of variable nozzle 110 can be reduced, again reducing the weight of second-stage vehicle 14.

Alternatively, flowpath 102 could be selectively lengthened in places other than the isolator or combustor to enhance the performance during scramjet operation. For example, length L₁ could be lengthened such that the contraction ratio of inlet 104 is decreased, and the expansion ratio in nozzle 110 can be decreased by lengthening length L₄.

FIG. 7 shows a schematic diagram of another embodiment of second-stage vehicle 14. In other embodiments of the present invention, an auxiliary rocket-based propulsion system can be integrated into second-stage vehicle 14, for example, to extend the operational range of vehicle 14 to earth-orbital missions and/or payload insertions. In one embodiment, rocket 114 is integrated within flowpath 116, which can operate as a scramjet, or a combined ramjet/scramjet as described above. Rocket 114 is used to assist the scramjet engine for orbital insertion and operation alone for maneuvering in space where a supply of oxygen is not available for the operation of air-breathing engines such as turbines, ramjets or scramjets. In another embodiment, rocket 118 is mounted externally to fuselage 120. As such, rocket 118 and/or rocket 114 is operable in conventionally known manners.

In another embodiment, second-stage vehicle 14 relies on only rocket propulsion. As such, the second-stage propulsion system primarily comprises only internally mounted rocket 114 without flowpath 116, or externally mounted rocket 118. In conjunction with the advantages achieved in first-stage vehicle 12, a rocket-based second-stage vehicle realizes increases in performance such as increases in cost per usable payload ratio and thrust-to-weight ratio, similar to performance increases realized in air-breathing second-stage vehicles such as in FIG. 6.

Although the present invention has been described with reference to preferred embodiments, workers skilled in the art will recognize that changes may be made in form and detail without departing from the spirit and scope of the invention.

1. A two-stage hypersonic vehicle comprising:
a first-stage vehicle for propelling the two-stage vehicle to a threshold velocity, the first-stage vehicle including:
a combined-cycle turbo-ramjet engine for producing thrust with combustion processes; and
a swirl generator for mixing combustion constituents in a combustion process of the combined-cycle engine; and
a second-stage vehicle detachably secured to the first-stage vehicle, the second-stage vehicle including a hypersonic engine for operating at the threshold velocity such that the second-stage vehicle is operable when detached from the first-stage vehicle.

2. The two-stage vehicle of claim 1 wherein the hypersonic engine comprises a scramjet engine.

3. The two-stage vehicle of claim 2 wherein the threshold speed comprises a speed viable for scramjet operation.

4. The two-stage vehicle of claim 2 wherein the threshold speed is approximately Mach 5 to approximately Mach 6.

5. The two-stage vehicle of claim 2 wherein the scramjet operates utilizing airflow having supersonic and above velocities as is produced by the propulsion of the first-stage vehicle by the combined-cycle turbo-ramjet engine.

6. The two-stage vehicle of claim 2 wherein the scramjet engine comprises:
an inlet for compressing a supersonic air flow;
a fuel injector for injecting a supply of a fuel into the supersonic air flow;
an expanding combustor for combusting the fuel in the supersonic air flow and accelerating the air flow; and
an exhaust nozzle for further accelerating the supersonic air flow to produce thrust as it exits the air-breathing hypersonic engine.

7. The two-stage vehicle of claim 2 wherein the second-stage vehicle further comprises a rocket-engine.

8. The two-stage vehicle of claim 1 wherein the hypersonic engine comprises a rocket-engine.

9. The two-stage vehicle of claim 1 wherein the hypersonic engine includes a combined ramjet and scramjet engine.

10. The two-stage vehicle of claim 1 wherein the combined-cycle turbo-ramjet engine comprises:
a gas turbine engine for providing initial thrusting of the two-stage vehicle and accelerating the two-stage vehicle to supersonic ramjet takeover speed; and
a ramjet engine for accelerating the two-stage vehicle to hypersonic threshold speed.

11. The two-stage vehicle of claim 10 wherein the swirl generator operates as an afterburner for the gas turbine engine.

12. The two-stage vehicle of claim 10 wherein the swirl generator operates as a ramjet engine.

13. The two-stage vehicle of claim 1 wherein the swirl generator comprises:
a centerbody for positioning in a flow stream of a first combustion constituent of the combined-cycle engine;
a vane pack for introducing a turbulent three-dimensional flowfield having a central recirculation zone downstream of the vane pack in the flow stream of the first combustion constituent;
a set of fuel injectors selected from the group consisting of wall-type, centerbody and bluffbody injectors, the set of fuel injectors for introducing a second combustion constituent into the three-dimensional turbulent flowfield;
a dump-step for anchoring an outer recirculation zone of the flow stream of the first combustion constituent and for anchoring a turbulent mixing-combusting shear layer of the outer recirculation zone of the combustion process;
an ignition system for initiating and sustaining a combustion process between the first combustion constituent and the second combustion constituent; and
a bluffbody for providing improved mixing of the combustion constituents, anchoring the central recirculation zone and for providing a flame anchor for the combustion process.

14. A propulsion system for a two-stage vehicle, the propulsion system comprising:
a first-stage propulsion system for a first-stage vehicle, the first-stage propulsion system comprising:
a combined-cycle engine for providing initial thrusting of the two-stage vehicle; and
a swirl generator for mixing combustion constituents in a combustion process of the first-stage propulsion system such that the two-stage vehicle is accelerated to a scramjet threshold speed;
a second-stage propulsion system for a second-stage vehicle detachably affixed to the first-stage vehicle, the second-stage propulsion system comprising a hypersonic engine for operating at the scramjet threshold speed and beyond.

15. The propulsion system of claim 14 wherein the hypersonic engine comprises a scramjet engine.

16. The propulsion system of claim 15 wherein the scramjet threshold speed comprises a speed viable for hypersonic operation.

17. The propulsion system of claim 15 wherein the scramjet threshold speed is approximately Mach 5 to approximately Mach 6.

18. The propulsion system of claim 15 wherein the scramjet operates utilizing airflow having supersonic and above velocities as is produced by the propulsion of the first-stage vehicle by the combined-cycle engine.

19. The propulsion system of claim 14 wherein the combined-cycle engine comprises:
a gas turbine engine for providing initial thrusting of the two-stage vehicle; and
a ramjet for accelerating the two-stage vehicle to supersonic speeds.

20. The propulsion system of claim 19 wherein the swirl generator operates as an afterburner for the gas turbine engine.

21. The propulsion system of claim 19 wherein the swirl generator operates as a ramjet engine.

22. The propulsion system of claim 19 wherein the first-stage propulsion system comprises a split-flow configuration wherein the combined-cycle engine and the ramjet occupy separate airflow space.

23. The propulsion system of claim 19 wherein the first-stage propulsion system comprises a combined-flow configuration wherein the combined-cycle engine and the ramjet share airflow space.

24. The propulsion system of claim 19 wherein the first-stage propulsion system includes variable ducting for controlling airflow through the first-stage propulsion system.

25. A two-stage vehicle comprising:
a first-stage vehicle powered by a combined-cycle engine having a swirl generator such that the first-stage vehicle achieves a staging Mach number from about Mach 5 to about Mach 6; and
a second-stage vehicle powered by a scramjet engine operable at the staging Mach number, wherein the scramjet engine is characterized by the absence of components necessary for subsonic operation.
